(19) United States
(12) Patent Application Publication
(10) Pub. No.: US 2020/0047724 A1
(43) Pub. Date: Feb. 13, 2020

(54) APPARATUS AND METHOD FOR WHEEL-ASSEMBLY AND TRACTION-MOTOR CHANGE OUT

(71) Applicant: Secure Energy (Onsite Services) Inc., Calgary (CA)

(72) Inventors: David MATTINSON, Calgary (CA); Charles WALSH, Okotoks (CA)

(73) Assignee: Secure Energy (Onsite Services) Inc.

(21) Appl. No.: 16/519,672

(22) Filed: Jul. 23, 2019

Related U.S. Application Data
(60) Provisional application No. 62/703,688, filed on Jul. 26, 2018.

(51) Int. Cl. B60S 9/22; B61F 5/04; B61F 13/00; B60S 11/00; B60K 5/10; B62D 43/00

(52) U.S. Cl. CPC B60S 9/22; B61F 5/04; B62D 43/002; B60S 11/00; B60K 5/10; B61F 13/00

(57) ABSTRACT

Disclosed herein is an apparatus for changing a traction motor and a wheel assembly out of a locomotive. The apparatus is suitable for use in the field. The apparatus comprises: (i) a frame that is dimensioned to fit under the locomotive and within a railroad track; (ii) a wheel-assembly-support system that is configured to support the wheel assembly such that the wheel assembly is clear of the track; (iii) a traction-motor-positioning system that is operable to position the traction motor with respect to the locomotive; and (iv) a drive assembly that is configured to drive the fame, the wheel-assembly-support system, and the traction-motor-positioning system under the locomotive in a reversible manner. The wheel-assembly-support system, the traction-motor-positioning system, and/or the drive assembly is/are operable by way of a remote control. Methods of changing a traction motor and/or wheel assembly out of a locomotive on a track are also provided.

### TECHNICAL FIELD

The present disclosure generally relates to mechanical services for railroad locomotives. In particular, the present disclosure relates to apparatus and methods for changing wheel assemblies and traction motors out of diesel-electric locomotives or diesel-electric locomotive cranes.

### BACKGROUND

Diesel-electric locomotives and diesel-electric locomotive cranes are used extensively in railroad operations. Diesel-electric locomotives and diesel-electric locomotive cranes both employ diesel-electric transmissions to provide motive power. In a typical diesel-electric transmission, a diesel internal combustion engine is configured to drive a rotor of a traction alternator. The traction alternator is electrically coupled to one or more traction motors, and each of the one or more traction motors is configured to drive a wheel assembly. A typical diesel-electric locomotive or diesel-electric locomotive crane may employ a number of traction motor/wheel assembly combinations (often referred to as “combos” by those skilled in the art).

Occasionally, traction motors or wheel assemblies fail during use. Historically, it has been impractical and/or unsafe to change out a failed traction motor/wheel assembly combination for an alternate traction motor/wheel assembly combination outside of a locomotive repair facility, primarily because traction motor/wheel assembly combinations are heavy and difficult to manipulate under field conditions with current technologies. Accordingly, when a traction motor/wheel assembly combination fails in the field, it is common practice to change out the traction motor/wheel assembly combination in favor of a “dummy” wheel assembly (i.e. a wheel assembly that does not have a traction motor coupled thereto) so that the locomotive can be diverted to a repair facility. At the repair facility, the dummy wheel assembly is typically changed out for an alternate traction motor/wheel assembly combination so the locomotive can be returned to service.

Common practices for changing out a traction motor/wheel assembly combination employ means for lifting at least a portion of a locomotive to provide access to the underside of the locomotive. Auxiliary Wrecking cranes and mobile-type cranes are commonly employed as means for lifting at least a portion of a locomotive.

### SUMMARY

The present disclosure identifies one or more inefficiencies inherent in the foregoing practices. The present disclosure further identifies that there is an unmet need in the railroad industry for apparatus and methods that allow for safe and efficient change outs of traction motor/wheel assembly combinations in the field.

The present disclosure contemplates this unmet need and provides an apparatus that enables traction motor/wheel assembly change out without requiring the specialized equipment of a locomotive repair facility. The apparatus of the present disclosure is intended to be used alongside a means for lifting at least a portion of a locomotive and can be employed in the field, in a rail yard, or in a repair facility. The apparatus of the present disclosure enables uninstallation of a traction motor/wheel assembly combination from a locomotive in a safe and efficient manner. Moreover, the apparatus of the present disclosure enables installation of a traction motor/wheel assembly combination on a locomotive in a safe and efficient manner. The present disclosure also provides methods for uninstalling/installing a traction motor/wheel assembly combination in a safe an efficient manner.

In select embodiments, the present disclosure relates to an apparatus for changing a traction motor and a wheel assembly out of a locomotive on a track. The apparatus comprises: (i) a frame that is dimensioned to fit under the locomotive and within the track; (ii) a wheel-assembly-support system that is connected to the frame, and that is configured to support the wheel assembly such that the wheel assembly is clear of the track; (iii) a traction-motor-positioning system that is connected to the frame adjacent to the wheel-assembly-support system, and that is operable to position the traction motor with respect to the locomotive; and (iv) a drive assembly that is connected to the frame, and that is configured to drive the fame, the wheel-assembly-support system, and the traction-motor-positioning system under the locomotive in a reversible manner. In such embodiments, the wheel-assembly-support system, the traction-motor-positioning system, the drive assembly, or a combination thereof is operable by way of a remote control.

In select embodiments, the present disclosure relates to a method for uninstalling a traction motor and a wheel assembly from a locomotive on a track. The method comprises: (i) driving an apparatus under the locomotive from a remote position; (ii) after at least a portion of the locomotive has been lifted such that the wheel assembly is clear of the track, operating the apparatus to support the wheel assembly with the apparatus such that the wheel assembly is clear of the track; (iii) operating the apparatus to support the traction motor of the locomotive with the apparatus; (iv) disengaging the wheel assembly and the traction motor from the locomotive; and (v) from a remote position, driving the apparatus out from under the locomotive.

In select embodiments, the present disclosure relates to a method for installing a traction motor and a wheel assembly on a locomotive on a track. The method comprises: (i) supporting the wheel assembly and the traction motor with an apparatus such that the wheel assembly is clear of the track; (ii) from a remote position, driving the apparatus under the locomotive when at least portion of the locomotive is in an elevated position relative to the track; (iii) operating the apparatus to lower the wheel assembly to engage with the track; (iv) lowering the locomotive to engage with the wheel assembly; (v) operating the apparatus to position the traction motor relative to the locomotive; (vi) engaging the traction motor with the locomotive; and (vii) from a remote position, driving the apparatus out from under the locomotive.

### BRIEF DESCRIPTION OF THE DRAWINGS

These and other features of the present disclosure will become more apparent in the following description in which reference is made to the appended drawings. The appended drawings illustrate embodiments of the present disclosure by way of example only and are not to be construed as limiting the scope of the present disclosure.

FIG. 1 is a perspective view of an apparatus in accordance with the present disclosure. The apparatus is a cart comprising a frame, a wheel-assembly-support system, a traction-motor-positioning system, and a drive assembly.

FIG. 2A is a side-on elevation view of the apparatus of FIG. 1. In FIG. 2A, the wheel-assembly-support system and the traction-motor-positioning system are each in an extend position.

FIG. 2B is an end-on elevation view of the apparatus of FIG. 1. In FIG. 2B, the wheel-assembly-support system and the traction-motor-positioning system are each in an extend position.

FIG. 3A is a side-on elevation view of the apparatus of FIG. 1. In FIG. 3A, the wheel-assembly-support system and the traction-motor-positioning system are each in a stowed position.

FIG. 3B is an end-on elevation view of the apparatus of FIG. 1. In FIG. 3B, the wheel-assembly-support system and the traction-motor-positioning system are each in a stowed position.

FIG. 4 is a side-on elevation view of an alternate apparatus in accordance with the present disclosure. In FIG. 4, the apparatus is supporting a wheel assembly/traction motor combination.

### DETAILED DESCRIPTION

As noted above, when a traction motor and/or wheel assembly fails in the field, it is common practice to change out the traction motor/wheel assembly combination in favor of a “dummy” wheel assembly (i.e. a wheel assembly that is not engaged with a traction motor) so that the locomotive can be diverted to a repair facility. At the repair facility, the dummy wheel assembly is typically changed out for an alternate traction motor/wheel assembly combination, so the locomotive can be returned to service. The present disclosure identifies one or more inefficiencies inherent in this practice. The present disclosure further identifies that there is an unmet need in the railroad industry for apparatus and methods that allow traction motor/wheel assembly combinations to be changed out in the field in a safe and efficient manner.

The present disclosure contemplates this unmet need and provides an apparatus that does not require the specialized equipment of a locomotive repair facility. The apparatus of the present disclosure is intended to be used alongside a means for lifting at least a portion of a locomotive and can employed in the field, in a rail yard, or in a repair facility. The apparatus of the present disclosure enables uninstallation a traction motor/wheel assembly combination from a locomotive in a safe and efficient manner. Moreover, the apparatus of the present disclosure enables installation a traction motor/wheel assembly combination on a locomotive in a safe and efficient manner. The present disclosure further provides methods for uninstalling/installing a traction motor/wheel assembly combination in a safe and efficient manner.

In the context of the present disclosure, a traction motor may be a type of electric motor that provides rotational torque to the wheel assembly. Those skilled in the art will recognize that traction motors of a variety of dimensions and weights may be used in railroad operations, and that traction motors may be generally classified as AC traction motors or DC traction motors. In the context of the present disclosure, a wheel assembly may comprise a pair of wheels, an axle, and optionally a gear member for engaging with a component of the traction motor. Those skilled in the art will recognize that wheel assemblies of a variety of dimensions and weights are used in railroad operations. By way of non-limiting example, the traction motor/wheel assembly combinations of the SW9 locomotive, the SD60 locomotive, and the MAC 90 locomotive weigh approximately 10,150 lbs (4,604 kg), 10,250 lbs (4,649 kg), and 12,450 lbs (5,647 kg), respectively. In the context of the present disclosure, “changing out” may refer to uninstalling, installing, or a combination thereof. Moreover, in the context of the present disclosure, “changing out” may refer to a traction motor, a wheel assembly, or a combination thereof. In the context of the present disclosure, a diesel-electric locomotive may be a locomotive that has a diesel-electric transmission. Accordingly, a diesel-electric locomotive may be a diesel-electric locomotive crane or may be a diesel-electric locomotive that is configured to drive a train. In the context of the present disclosure, a diesel-electric locomotive may be a diesel-electric locomotive that utilizes a battery in a hybrid system such as a Green Goat® locomotive (Green Goat is a registered trademark of RailPowers Technologies Corporation, Brossard, Quebec, Canada). In the context of the present disclosure, a track may comprise a plurality of rails, a plurality of fasteners, a plurality of ties, ballast, underlying subgrade, or a combination thereof.

In select embodiments, the present disclosure relates to an apparatus that comprises a frame. The frame is dimensioned to enable the apparatus to pass under the locomotive and fit within the track. With respect to the frame being dimensioned such that the apparatus can pass under the locomotive, those skilled in the art will recognize that such frames (and such apparatus) may take a variety of dimensions as locomotives may have a variety of under-clearance dimensions and tracks may have a variety of rail heights. By way of non-limiting example, a typical diesel-electric locomotive in Canada or the United States riding on 100 pound rail may have an under clearance of about 10½″ (26.67 cm) with about 6″ (15.24 cm) of the under clearance being attributable to the rail. Thus, the frame (and the apparatus) may have a height of less than about 10″ (25.4 cm). In a preferred embodiment, the frame may have a height of about 7″ (25.4 cm). With respect to the frame (and the apparatus) being dimensioned to fit within the track, those skilled in the art will recognize that tracks employed in railroad operations may have a variety of track gauges (i.e. rail spacings). By way of non-limiting example, relatively narrow tracks may have track gauges of about 2′ 6″ (762 cm), standard tracks may have track gauges of about 4′ 8½″ (1,435 cm), and relatively broad tracks may have track gauges of about 5′ 6″ (1,676 cm). Thus, the frame (and the apparatus) may have a width of less than about 2′ 6″ (762 cm), less than about 4′ 8½″ (1,435 cm), or less than about 5′ 6″ (1,676 cm). In a preferred embodiment, the frame may have a width of about 3′ 6″ (1,097 cm). The frame may be comprised of any material that is suitable to support a traction motor, a wheel assembly, or a combination thereof. By way of non-limiting example, the frame may be comprised of steel, aluminum, or a combination thereof. The frame may comprise a plurality of members that are connected by welding, bolting, riveting, or a combination thereof.

In select embodiments, the present disclosure relates to an apparatus that comprises a wheel-assembly-support system in addition to a frame. The wheel-assembly-support system may be connected to the frame by a variety of means provided that the connection is sufficiently robust to support a wheel assembly. By way of non-limiting example, the wheel-assembly-support system may be connected to the frame by welding, bolting, or riveting the wheel-assembly support system to the frame. The wheel-assembly-support system may be configured to engage the wheels of the wheel assembly, the axle of the wheel assembly, or a combination thereof. The wheel-assembly-support system may engage the wheel assembly such that the wheel assembly is clear of the track. In the context of the present disclosure, a wheel assembly is clear of a track when the wheel assembly is not directly contacting the track. By way of non-limiting example, a wheel assembly is clear of a track, when wheels of the wheel assembly are supported above the track, or adjacent to the track. By way of a further non-limiting example, a wheel assembly is clear of a track, when wheels of the wheel assembly are directly supported by a plurality of wheel cradles which are components of the apparatus and which are configured to ride on the rails of the railway track. The wheel-assembly-support system may be stationary. Alternatively, the wheel-assembly-support system may be configured to move between an extended position and a stowed position—optionally by way of a plurality of intermediate positions. The plurality of intermediate positions may be indexed between the stowed position and the extended position, or the plurality of intermediate positions may be a continuum between the stowed position and the extended position. Transitioning the wheel-assembly-support system to the stowed position, the extended position, at least one of the plurality of intermediate positions, or a combination thereof may provide a means to position the wheel assembly relative to the locomotive, the track, or a combination thereof. The wheel-assembly-support system may comprise a hydraulic lift to transition the wheel-assembly-support system to the stowed position, the extended position, at least one of the plurality of intermediate positions, or a combination thereof. The hydraulic lift may be operable from a distance by way of a remote control.

In select embodiments, the present disclosure relates to an apparatus that comprises a traction-motor-positioning system in addition to a frame and a wheel-assembly-support system. The traction-motor-positioning system may be connected to the frame by a variety of means provided that the connection is sufficiently robust to support a traction motor. By way of non-limiting example, the wheel-assembly-support system may be connected to the frame by welding, bolting, or riveting the traction-motor-positioning system to the frame. The traction-motor-positioning system may be configured to engage the traction motor in a variety of ways. By way of non-limiting example, the traction-motor-positioning system may be configured to engage the traction motor with a cross-tube assembly. The cross-tube assembly may be symmetric about a longitudinal axis and rotatable about the longitudinal axis. As such, the cross-bar assembly may be configured to “roll” along a surface of the traction motor as the position of the traction-motor-positioning system is manipulated. The traction-motor-positioning system may be configured to move between an extended position and a stowed position—optionally by way of a plurality of intermediate positions. The plurality of intermediate positions may be indexed between the stowed position and the extended position, or the plurality of intermediate positions may be a continuum between the stowed position and the extended position. Transitioning the traction-motor-positioning system to the stowed position, the extended position, at least one of the plurality of intermediate positions, or a combination thereof may provide a means to position the traction motor relative to the locomotive. The wheel-assembly-support system may comprise a hydraulic lift, a pneumatic lift, an electric lift, or a combination thereof to transition the wheel-assembly-support system to the stowed position, the extended position, at least one of the plurality of intermediate positions, or a combination thereof. Such lifts may be operable from a distance by way of a remote control.

In select embodiments, the present disclosure relates to an apparatus that comprises a drive assembly in addition to a frame a wheel-assembly-support system, and a traction-motor-positioning system. The drive assembly may be connected to the frame by a variety of means provided that the drive assembly is configured to drive the frame, the wheel-assembly-support system, and the traction-motor-positioning system under the locomotive. The drive assembly may take a variety of forms. By way of non-limiting example, the drive assembly may comprise a plurality of rollers. The rollers may be passive, driven, or a combination thereof. The rollers may be configured to ride on a cart track that is configured to fit within the railroad track. As a further non-limiting example, the drive assembly may comprise a continuous track that is configured to drive the apparatus. The drive assembly may be configured to drive in a reversible manner such that the drive assembly provides a means to move the apparatus from a position that is not under the locomotive to a position that is under the locomotive and vice versa. The drive assembly may be operable by way of a remote control.

In select embodiments, the present disclosure relates to a method for uninstalling a traction motor and a wheel assembly from a locomotive on a track. In the context of the present disclosure, “uninstalling” refers to one or more actions that result in a traction motor, a wheel assembly, or a combination thereof being temporarily or permanently disengaged from a locomotive. The method comprises driving an apparatus under the locomotive from a remote position. After at least a portion of the locomotive has been lifted such that the wheel assembly is clear of the track, the method further comprises operating the apparatus to support the wheel assembly with the apparatus such that the wheel assembly is clear of the track. Those skilled in the art will recognize that a variety of means may be employed to lift at least a portion of a locomotive may be executed by a variety of means. By way of non-limiting example, at least a portion of a locomotive may be lifted by an auxiliary wrecking crane or a mobile-type crane. The method further comprises operating the apparatus to support the traction motor with the apparatus, and disengaging the wheel assembly and the traction motor from the locomotive. Those skilled in the art will recognize that disengaging the wheel assembly and the traction motor from the locomotive may involve one or more of a variety of actions having regard to the type of wheel assembly, the type of traction motor, the type of locomotive, or a combination thereof. The method further comprises, from a remote position, driving the apparatus out from under the locomotive.

In select embodiments of the present disclosure, the driving of the apparatus under the locomotive may precede the lifting of at least a portion of the locomotive and the operating of the apparatus to support the wheel assembly. Alternatively, the lifting of at least a portion of the locomotive may precede the driving of the apparatus under the locomotive. Moreover, driving of the apparatus under the locomotive, the operating of the apparatus to support the wheel assembly, or a combination thereof may occur concurrently with the lifting of at least a portion of the locomotive.

In select embodiments of the present disclosure, the operating of the apparatus to support the wheel assembly may precede the operating of the apparatus to support the traction motor. Alternatively, the operating of the apparatus to support the traction motor may precede the operating of the apparatus to support the wheel assembly. Moreover, the operating of the apparatus to support the wheel assembly, the operating of the apparatus to support the traction motor, or a combination thereof may be concurrent with the lifting of the locomotive.

More generally, those skilled in the art will appreciate that methods for uninstalling a wheel assembly and a traction motor from a locomotive are iterative in nature and that the steps of the methods may be practiced in a variety of sequences having regard to the type of wheel assembly, the type of traction motor, and the type of locomotive. By way of non-limiting example, the methods of the present disclosure may be adapted to suit the specific requirements of a diesel-electric locomotive that is configured to pull a train or to suit the specific requirements of a diesel-electric locomotive crane. Likewise, the methods of the present disclosure may be adapted to AC diesel-electric locomotives or DC diesel electric locomotives.

In select embodiments of the present disclosure, the method for uninstalling a traction motor and a wheel assembly on a locomotive may be executed outside of a major terminal. Alternatively, the method for installing a traction motor and a wheel assembly on a locomotive may be executed inside of a major terminal. In the context of the present disclosure, a major terminal is one which includes a locomotive repair facility.

Select embodiments of the present disclosure relate to a method for installing a traction motor and a wheel assembly on a locomotive on a track. In the context of the present disclosure, “installing” refers to one or more actions that result in a traction motor, a wheel assembly, or a combination thereof being temporarily or permanently engaged with a locomotive. The method comprises supporting the wheel assembly and the traction motor with an apparatus such that the wheel assembly is clear of the track. The method further comprises, from a remote position, driving the apparatus under the locomotive when at least portion of the locomotive is in an elevated position relative to the track. The method further comprises operating the apparatus to lower the wheel assembly to engage with the track and lowering the locomotive to engage with the wheel assembly. Those skilled in the art will recognize that lowering a locomotive may be executed by a variety of means. By way of non-limiting example, at least a portion of a locomotive may be lowered by an auxiliary wrecking crane or a mobile-type crane. The method further comprises operating the apparatus to position the traction motor relative to the locomotive and engaging the traction motor with the locomotive. The method further comprises, from a remote position, driving the apparatus out from under the locomotive.

Those skilled in the art will appreciate that methods for installing a wheel assembly and a traction motor on a locomotive are iterative in nature and that the steps of the methods may be practiced in a variety of sequences having regard to the type of wheel assembly, the type of traction motor, and the type of locomotive. By way of non-limiting example, the methods of the present disclosure may be adapted to suit the specific requirements of a diesel-electric locomotive that is configured to pull a train or to the specific requirements a diesel-electric locomotive crane. Likewise, the methods of the present disclosure may be adapted to AC diesel-electric locomotives or DC diesel electric locomotives.

In select embodiments of the present disclosure, the method for installing a traction motor and a wheel assembly on a locomotive may be executed outside of a major terminal. Alternatively, the method for installing a traction motor and a wheel assembly on a locomotive may be executed inside of a major terminal.

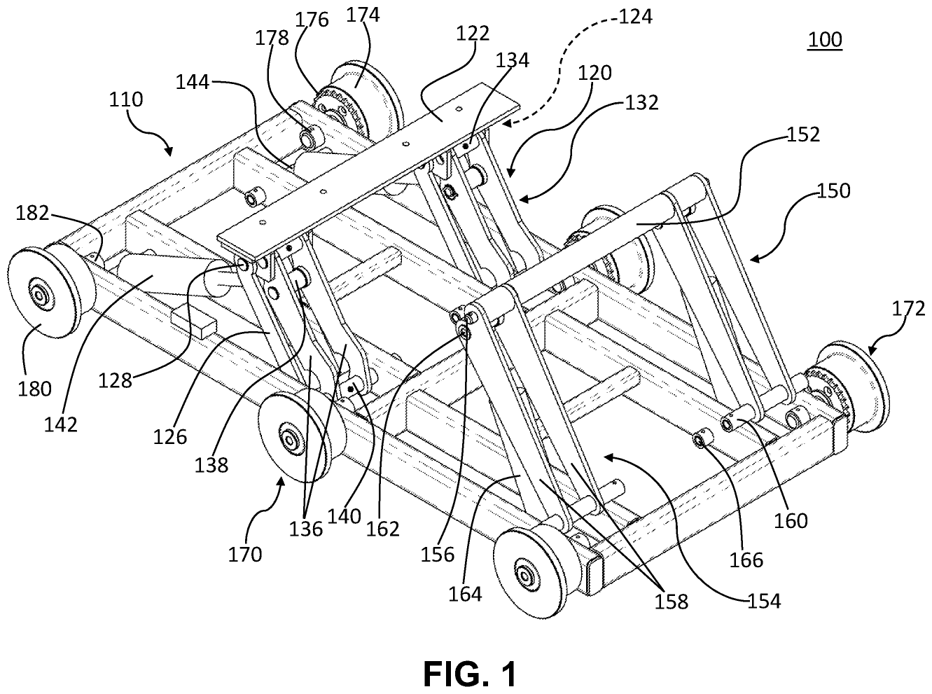

Embodiments of the present disclosure will now be described by reference to FIG. 1 to FIG. 4.

FIG. 1 is a perspective view of an apparatus in accordance with the present disclosure. The apparatus is a cart 100 that is configured for changing a traction motor and a wheel assembly out of a diesel-electric locomotive on a track. The cart 100 has a maximum carrying capacity of about 16,000 lbs (7,257 kg). The cart 100 comprises a frame 110, a wheel-assembly-support system 120, a traction-motor-positioning system 150, and a drive assembly 170.

The frame 110 is substantially rectangular and is dimensioned to fit under the locomotive and within the track. In particular, the frame 110 has a length dimension of about 72″ (183 cm) and a width dimension of about 44″ (112 cm). The frame 110 is comprised of a plurality of steel members that are welded together.

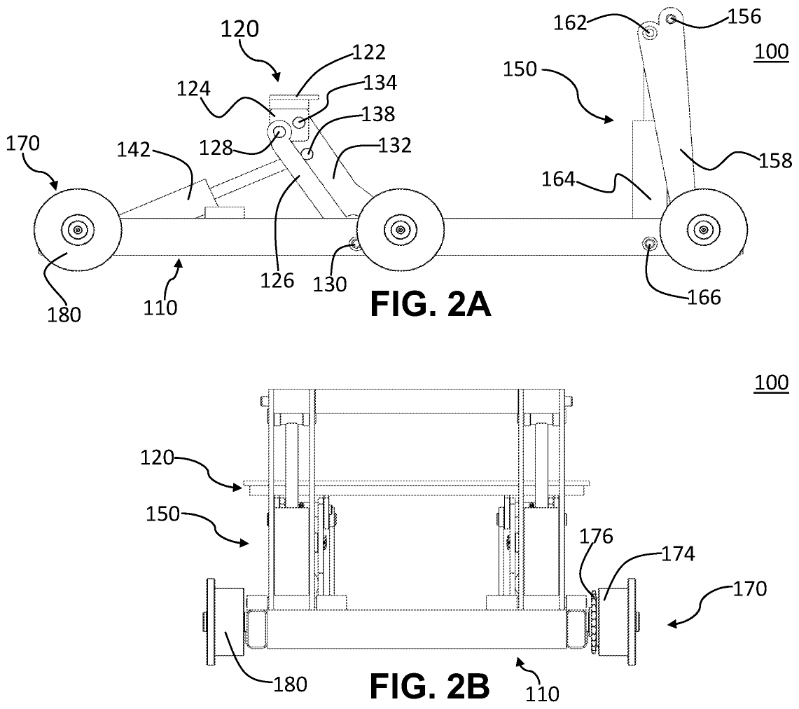

The wheel-assembly-support system 120 is connected to the frame 110 and is configured to support the wheel assembly such that the wheel assembly is clear of the track. The wheel-assembly-support system 120 comprises a levelling plate 122 that is oriented to be substantially parallel to the width dimension of the frame 110 and that is configured to engage the wheel assembly. The levelling plate 122 sits atop a leveling assembly 124 that is connected to a plurality of levelling arms 126 by way of pins 128. Each of the plurality of leveling arms 126 is connected to the frame 110 by way of a pin 130 (best seen in FIG. 2A). The leveling assembly 124 is also connected to a pair of lifting assemblies 132 by way of pins 134. Each of the pair of lifting assemblies 132 comprises a pair of lifting arms 136 which are separated by a pin 138. Each of the lifting arms 136 is connected to the frame by way of a pin 140. Each of the pair of lifting assemblies 132 is connected to a hydraulic cylinder 142. In particular, a first end of each of the hydraulic cylinders 142 engages with the frame 110 by way of a pin 144 and a second end of each of the hydraulic cylinders 142 engages with the pin 138. As such, expansion and contraction of the hydraulic cylinders 144 provides for vertical displacement of the levelling assembly 124 and the leveling plate 122. The vertical displacement available to the wheel-assembly-support system 120 is between about 0″ and 17″. The range of angles available to the wheel-assembly-support system 150 with respect to the frame 110 is between about 0° and about 90°.

The traction-motor-positioning system 150 is connected to the frame 110 adjacent to the wheel-assembly-support system 120. The traction-motor-positioning system 150 is configured to position the traction motor with respect to the locomotive. The traction-motor-positioning system 150 comprises a cross-tube assembly 152 that is oriented to be substantially parallel to the width dimension of the frame 110. The cross-tube assembly 152 is connected to a pair of lifting assemblies 154 by way of pins 156. Each of the pair of lifting assemblies 154 comprises a pair of lifting arms 158 which are separated at a first end by a pin 160 and by the pins 156 at a second end. The pin 160 is rotatably fixed to the frame 110. Each of the lifting assemblies 154 further comprises a pin 162 that is proximal to the pin 156. In each of the lifting assemblies 154, the pin 162 is interposed between the lifting arms 158, and each of the pair of lifting assemblies 154 is connected to a hydraulic cylinder 164 by way of the pin 162. In particular, a first end of each of the hydraulic cylinders 164 engages with the frame 110 by way of a pin 166 and a second end of each of the hydraulic cylinders 164 engages with the pin 162. As such, expansion and contraction of the hydraulic cylinders 164 provides for vertical displacement of the cross-tube assembly 152. The cross-tube assembly 152 is configured to engage the traction motor by rolling along a surface of the traction motor as part of the process of positioning the traction-motor-positioning system. The range of angles available to the traction-motor-positioning system 150 with respect to the frame 110 is between about 0° and about 75°. The vertical displacement available to the traction-motor-positioning system 150 is between about 0″ and 17″.

The drive assembly 170 is connected to the frame 110 and is configured to drive the fame 110, the wheel-assembly-support system 120, and the traction-motor-positioning system 150 under the locomotive in a reversible manner. The drive assembly 170 comprises a plurality of driven rollers 172, each of which comprises a roller 174, a gear member 176, and a pin 178. The pin 178 connects the roller 174 to the frame 110 and provides for rotation of the roller 174. The gear member 176 is fixed with respect to roller 174 such that driving the gear member 174 provides for rotation of the roller 174 and movement of the cart 100. The drive assembly 170 further comprises a plurality of passive rollers 180 that are connected to the frame 110 opposite to the plurality of driven rollers 172. The passive rollers 180 are connected to the frame 110 by pins 182.

FIG. 2A is a side-on elevation view of the cart 100, and FIG. 2B is an end-on elevation view of the cart 100. In FIG. 2A and FIG. 2B, the wheel-assembly-support system 120 and the traction-motor-positioning system 150 are each in an extend position. In such a configuration, the wheel-assembly-support system 120 is positioned to support the wheel assembly such that the wheel assembly is clear of the track and to position the wheel assembly by adjusting the displacement of the hydraulic 142. Likewise, in such a position, the traction-motor-positioning system 150 is configured to position the traction motor with respect to the locomotive by adjusting the displacement of the hydraulics 164.

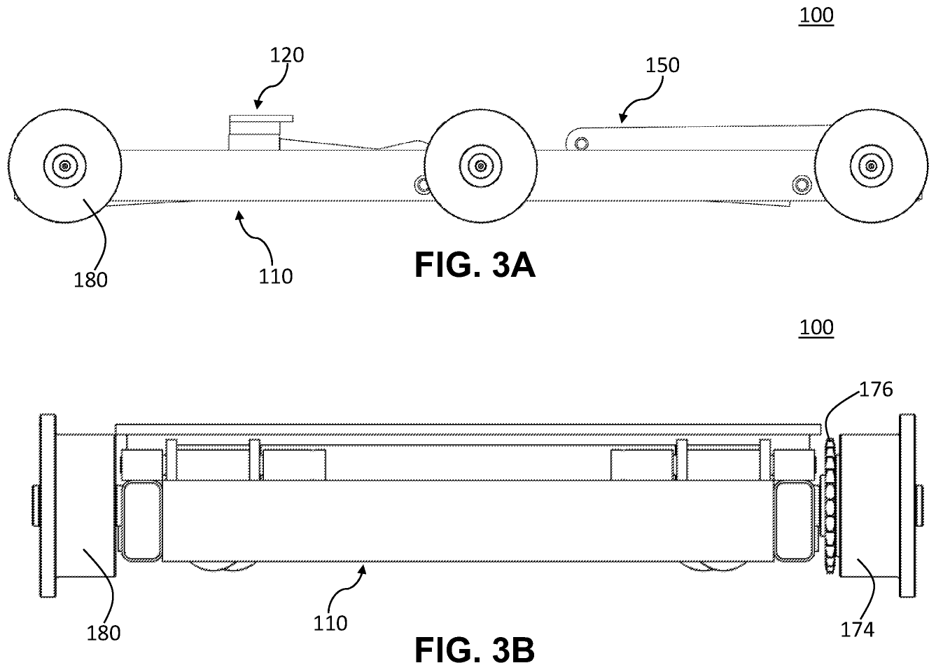

FIG. 3A is a side-on elevation view of the apparatus of FIG. 1, and FIG. 3B is an end-on elevation view of the apparatus of FIG. 1. In FIG. 3A and FIG. 3B, the wheel-assembly-support system 120 and the traction-motor-positioning system 150 are each in a stowed position. In such a configuration, the wheel-assembly-support system 120 is positioned to pass under the wheel assembly and then raise up thereto by increasing the displacement of the hydraulics 142. Likewise, in such a position, the traction-motor-positioning system 150 configured to pass under the traction motor and then raise up to position the traction motor with respect to the locomotive by adjusting the displacement of the hydraulics 164.

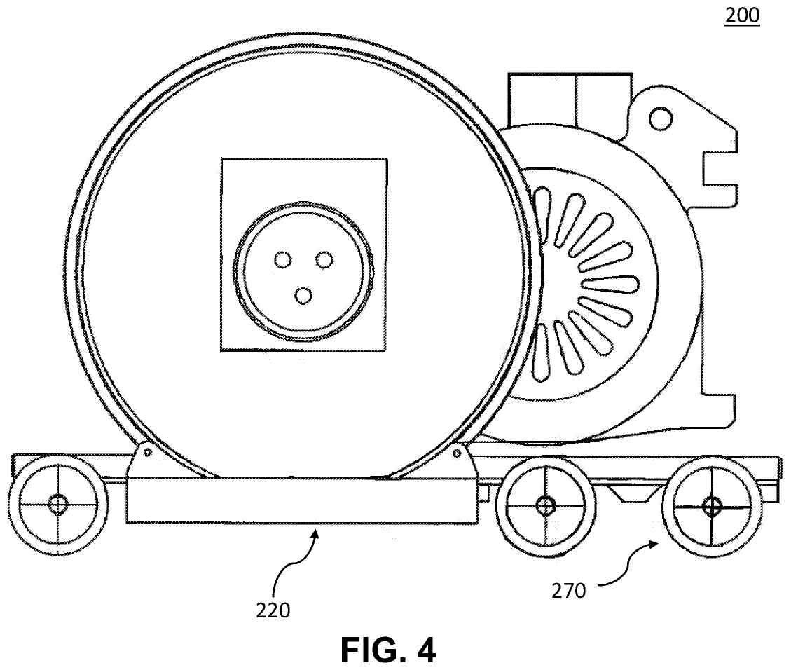

FIG. 4 is a side-on elevation view of an alternate apparatus 200 that is in accordance with the present disclosure. In FIG. 4, the apparatus 200 is supporting a wheel assembly/traction motor combination. The apparatus 200 comprises a wheel-assembly-support system 220 that is stationary and that is configured to receive the wheels of the wheel assembly. The apparatus 200 further comprises a drive assembly 270 that is configured to ride on rails of the railroad track.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. Many obvious variations of the embodiments set out herein will suggest themselves to those skilled in the art in light of the present disclosure. Such obvious variations are within the full intended scope of the appended claims.

1. An apparatus for changing a traction motor and a wheel assembly out of a locomotive on a track, the apparatus comprising:
a frame that is dimensioned to fit under the locomotive and within the track;
a wheel-assembly-support system that is connected to the frame, and that is configured to support the wheel assembly such that the wheel assembly is clear of the track;
a traction-motor-positioning system that is connected to the frame adjacent to the wheel-assembly-support system, and that is operable to position the traction motor with respect to the locomotive; and
a drive assembly that is connected to the frame, and that is configured to drive the fame, the wheel-assembly-support system, and the traction-motor-positioning system under the locomotive in a reversible manner,
wherein the wheel-assembly-support system, the traction-motor-positioning system, the drive assembly, or a combination thereof is operable by way of a remote control.

2. The apparatus of claim 1, wherein the traction-motor-positioning system comprises a hydraulic lift.

3. The apparatus of claim 1, wherein the traction-motor-positioning system comprises a cross-tube assembly that is configured to engage the traction motor and to roll along a surface of the traction motor.

4. The apparatus of claim 1, wherein the wheel-assembly-support system comprises a hydraulic lift.

5. The apparatus of claim 1, wherein the wheel-assembly-support system comprises a plurality of cradles that are configured to receive wheels of the wheel assembly.

6. The apparatus of claim 1, wherein the drive assembly comprises a plurality of rollers.

7. The apparatus of claim 6, wherein one or more of the plurality of rollers is configured to drive the apparatus.

8. The apparatus of claim 1, wherein the apparatus is a cart that is configured to ride on a cart track.

9. A method for uninstalling a traction motor and a wheel assembly from a locomotive on a track, the method comprising:
(i) driving an apparatus under the locomotive from a remote position;
(ii) after at least a portion of the locomotive has been lifted such that the wheel assembly is clear of the track, operating the apparatus to support the wheel assembly with the apparatus such that the wheel assembly is clear of the track;
(iii) operating the apparatus to support the traction motor with the apparatus;
(iv) disengaging the wheel assembly and the traction motor from the locomotive; and
(v) from a remote position, driving the apparatus out from under the locomotive.

10. The method of claim 9, wherein the driving of the apparatus under the locomotive occurs before the locomotive has been lifted.

11. The method of claim 9, wherein the driving of the apparatus under the locomotive occurs after the locomotive has been lifted.

12. The method of claim 9, wherein the operating of the apparatus to support the wheel assembly step occurs before the operating of the apparatus to support the traction motor.

13. The method of claim 9, wherein the operating of the apparatus to support the wheel assembly step occurs after the operating of the apparatus to support the traction motor.

14. The method of claim 9, which is executed outside of a major terminal.

15. The method of claim 9, which is executed inside of a major terminal.

16. A method for installing a traction motor and a wheel assembly on a locomotive on a track, the method comprising:
(i) supporting the wheel assembly and the traction motor with an apparatus such that the wheel assembly is clear of the track;
(ii) from a remote position, driving the apparatus under the locomotive when at least portion of the locomotive is in an elevated position relative to the track;
(iii) operating the apparatus to lower the wheel assembly to engage with the track;
(iv) lowering the locomotive to engage with the wheel assembly;
(v) operating the apparatus to position the traction motor relative to the locomotive;
(vi) engaging the traction motor with the locomotive; and
(vii) from a remote position, driving the apparatus out from under the locomotive.

17. The method of claim 16, which is executed outside of a major terminal.

18. The method of claim 16, which is executed inside of a major terminal.
